(19) United States
(12) Patent Application Publication
(10) Pub. No.: US 2008/0126980 A1
(43) Pub. Date: May 29, 2008

(54) CENTRAL DISPLAY FLOOR PLAN FOR DISPLAYING A PLURALITY OF DATA OBJECTS

(75) Inventors: Martin BACHMANN, Heidelberg (DE); Daniel BRAXTON, Plankstadt (DE); Holger KIEFHABER, Karlsruhe (DE); Peer HILGERS, St. Leon-Rot (DE); Leif JENSEN-PISTORIUS, Ostringen (DE)

Correspondence Address: KENYON & KENYON LLP, ONE BROADWAY, NEW YORK, NY, 10004, US

(73) Assignee: SAP AG, Walldorf (DE)

(21) Appl. No.: 11/946,144

(22) Filed: Nov. 28, 2007

Related U.S. Application Data
(60) Provisional application No. 60/861,826, filed on Nov. 29, 2006.

(51) Int. Cl. G06F 3/048

(52) U.S. Cl. 715/804

(57) ABSTRACT

A computer running executable code is operative to provide a floor plan for displaying a plurality of data objects. The method includes receiving a user input request for product information and retrieving a plurality of data objects from at least one object database. The object database may be local or remotely connection. The method, as may be implemented on the processing device, further includes recognizing a selected viewable tab of the central display floor plan and generating a visual output display including disposing the one or more data objects in predefined positions. The method includes determining a first object link to a previous output display and including the first object link in the visual output display. Thereby, the floor plan includes displaying the data objects and the dynamic navigation links.

### CROSS-REFERENCE TO RELATED APPLICATIONS

This application claims the benefit of and priority to U.S. Provisional Patent Application No. 60/861,826, to Martin Bachmann, Daniel Braxton, Holger Kiefhaber, Peer Hilgers, and Leif Jensen-Pistorius, filed on Nov. 29, 2006, entitled “Floor Plan for Browsing, Analyzing, and Navigating Across Multiple, Interrelated Business Objects,” which is hereby incorporated by reference in its entirety.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND

The present invention relates generally to a user interface for accessing varying degrees of database data and more specifically to a general floor plan for displaying a plurality of data objects in a context-specific, navigation directionally enhanced, tab-based display.

There are common interfaces for accessing database data. In a typical implementation, the interface includes rigid formats and data structures that are then populated with the database data. For example, an interface may relate to product information and product development, so the pages may include preset locations for figures and other areas for text or specification information. This type of interface is very static and does not lend itself to individualized customization for different users with the different needs. Also, this static interface does not work well with large degrees of information because of inherent navigation limitations, such as the predefined forms not including links for navigating between different screens.

These existing interfaces allow for basic data interface, which may include accessing a database to retrieve a specific piece of data, making a change to the data, such as updating the data, and then storing the data back into the database. Being able to only interface with a single data object at one time significantly restricts this static interface. If a user attempted to access a second object, the existing interfaces require launching a second concurrent interface instead of being able to be readily integrated with the first interface.

A floor plan, as used herein, refers to a pre-set combination of window contents. The existing floor plans fail to provide the user with consistent, repeatable, and context-specific views on a complex business object for purposes of information gathering, such as browsing, analysis and navigation to other related objects. A complex business object includes a composite business object that may include one or more subordinate technical objects. By way of example, a product may include any number of subordinate objects such as materials, bills of material, change management records, routings and requirement specifications.

Existing interface floor plans are unable to manage these business objects because of the complex nature of the objects themselves. The interface must be specifically customized for each implementation to accommodate the different business objects, which is not a realistic implementation. Additionally, should any changes be made to the data structure of the business objects (e.g. adding another object field), this would inherently require updating the interface to accommodate this information, yet another unrealistic implementation.

The current floor plans also lack the ability to enable the user to navigate across a selection of objects both in a forward and a backward direction within a single instance of the floor plan. As the existing floor plans cannot accommodate the objects, they are unable to include navigation functionality by using object links to link between different objects. The existing floor plans fail to allow a user to dynamically create a bread-crumb trail to either trace the user's movements along a selected hierarchy of objects and identify a current object's position in relation to the other technical objects within the selected object hierarchy.

### BRIEF DESCRIPTION OF THE DRAWINGS

FIG. 1 illustrates a block diagram of one embodiment of a system for displaying a plurality of data objects in a central floor plan;

FIG. 2 illustrates a block diagram of one embodiment of an apparatus for displaying a plurality of data objects in a central floor plan;

FIG. 3 illustrates a flowchart of the steps of one embodiment of a method for displaying a plurality of data objects in a central floor plan;

FIGS. 4-8 illustrate sample screen shots of one embodiment of a central floor plan displaying a plurality of data objects; and

FIG. 9 illustrates a block diagram of another embodiment of an apparatus for displaying a plurality of data objects in a central floor plan.

### DETAILED DESCRIPTION

A floor plan provides for the display of a plurality of data objects. The method includes receiving a user input request for product information and retrieving a plurality of data objects from at least one object database. The object database may be local or remotely connected. The method, as may be implemented on the processing device, further includes recognizing a selected viewable tab of the central display floor plan and generating a visual output display including disposing the one or more data objects in predefined positions. The method includes determining a first object link to a previous output display and including the first object link in the visual output display. Thereby, the floor plan includes displaying the data objects and the dynamic navigation links.

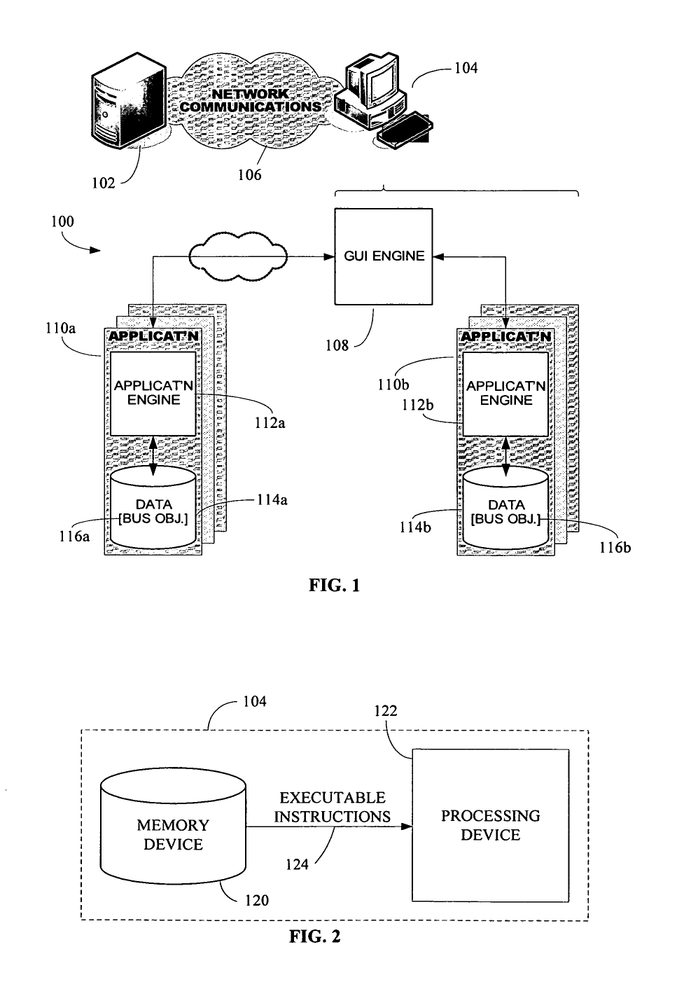

More specifically, FIG. 1 illustrates one embodiment of a system 100 for displaying a plurality of data objects in a central floor plan. The system 100 includes a first computing device 102 and a second computing device 104 in communication across network communications 106. Within the second computing device 104 is a GUI engine 108 operative with a plurality of applications 110a, 110b. Each of the applications 110 include an application engine 112 and one or more object databases 114 having data objects 116 stored therein.

The object databases 114 may be local or remote, whereby access may be facilitated by any available means, such as a networked connection allowing for access thereto. Data objects 116 may be information and/or sub-objects relating to a particular data element and may be stored in one or more of the databases 114. As discussed in further detail below, the floor plan within the GUI engine 108 provides for the user to view, analyze and adjust these data objects 116.

FIG. 2 illustrates an embodiment of a processing unit inside the computing device 104 which includes a memory device 120 and a processing device 122, which may be one or more processors. The processing device 122 is operative to receive executable instructions 124 from the memory device 120, where these executable instructions 124 may include instructions for interactive operations providing the central floor plan through the GUI engine 108 of FIG. 1.

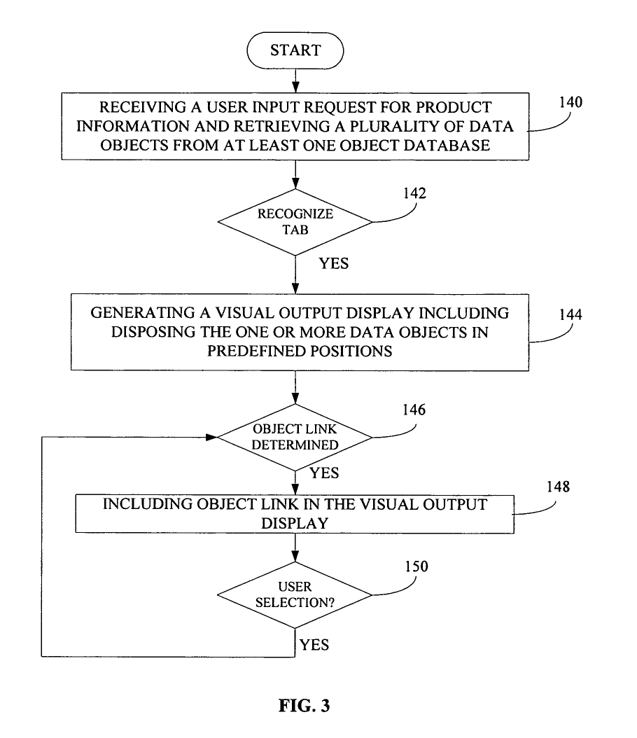

One embodiment of the operation of the processing system 100 is illustrated in flowchart of FIG. 3. In one embodiment of operation, the first step 140 is receiving a user input request for product information. A user input request may be received from the requesting computing device 102 and received by the computer or terminal 104 having the processing device 122 which may be within the GUI engine 108. By way of example, the input may be received over a networked connection if a user is accessing data objects through a terminal or otherwise networked communication approach. The user input request may be a typed request, such as entering a product identifier or other known interfacing techniques for receiving input information. This step, 140, may also include retrieving a plurality of data objects from at least one object database. The processing unit 104 may route a data retrieval request for accessing the proper database 114 and retrieving the data object 116. This retrieval request may be performed using known data retrieval techniques.

In one embodiment, a next step, step 142, may be recognizing a selection of a viewable tab of the central display floor plan. As discussed in further detail below, the central display floor plan may include a tabbed window display whereby various windows are selectable by a user selecting different tabs. Common tab-browsing techniques are known, for example in the existing FireFox Internet browser commonly available. The recognition of the selected viewable tab by the processing unit 104 provides for the adjustment of the output display such that various elements of a data object may be displayed based on the selected tab.

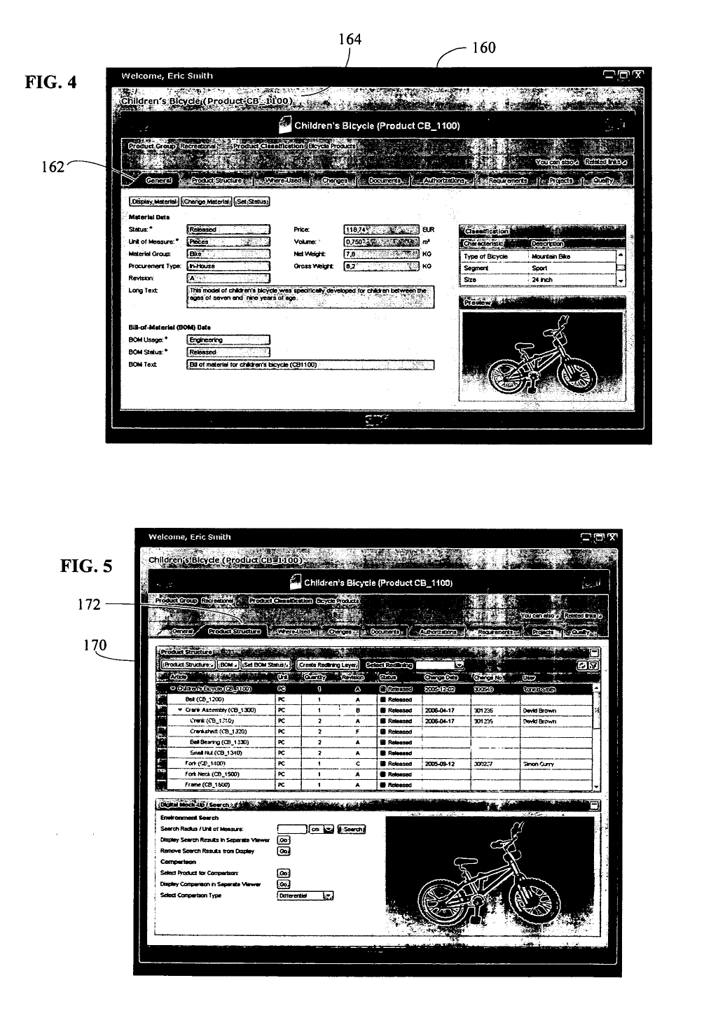

Upon recognizing a tab selection, the next step, step 144, in one embodiment, is generating a visual output display including disposing the one or more data objects in predefined positions. By way of example and as described in further detail below, FIGS. 4-8 illustrate various screen shots including disposition of various data objects in predefined positions.

In one embodiment, a next step, step 146, is determining a first object link to a previous output display. An object link may be an active hyperlink to a previous display or structure within a data hierarchy. This object link may be an active link such that upon user selection of this link, the central display floor plan directs a viewable screen to this linked position. In one embodiment, the object link may reference a dynamically designated visual display stored in a temporary storage or may, in another embodiment, reference one or more recreation instructions for regenerating or recreating a particular display or a position in a data hierarchy.

If the object link is determined, which may include the generation of the object link itself or retrieving the object link from a references table or queue, thereupon, the next step, step 148, is including the object link in the visual output display. For a first display in the sequence of displays, this object link may be a first object link. This object link may be an active link such that upon user selection, the user is directed to this display. Thereupon, the floor plan creates a dynamic navigation trail for the user between varying display screen and positions within the data hierarchy.

The floor plan as executed through the GUI interface 108 may provide for additional user interaction beyond the flowchart of FIG. 3. For example, the floor plan 112 may include generating a second object link for the visual output display, where the second object link relates to the presently displayed visual output. This second object link may be included in future displays for additional navigation. Whereas, in the flowchart of FIG. 3, a next step is the determination of the receipt of a user navigation selection, step 150. This selection may include selecting a tab or otherwise instructing the GUI interface to redirect the user for viewing additional or different information. In these operations, when a navigation selection is detected, the method reverts back to step 146 where another object link is determined. In the above example of a second visual display, the object link may be a second object link.

Through the continued use of the floor plan, the processing unit 104 may receive a second user input request for product information, such as receiving a typed input or a graphical user interface selection for example. The processing device 122 determines if any additional data objects are being requested and if so, retrieves additional data objects 116 from the databases 114. A user may also select or request a new viewable tab on the display, therefore a new tab window may be generated within the central floor plan and the updated visual display includes not only the requested data objects, but also the second object link. This second object again allows a user to navigate back to the previous display using the same technique as described above for the first object link.

In navigating through the floor plan, the processing device 122 generates a third object link for the updated visual display described above, as may generated through the repeated operations of steps 146-150. This third object link allows user navigation back to the updated visual display. Therefore, if a user generates another visual display or navigates back to the previous display, such as selecting the second data object link, the third data object link is visible and active in the window display.

In one embodiment, objects may be provided in a read-only mode. This thereby prevents unauthorized or accidental modification of the data objects 116 as stored in the object databases 114. Thereby, while in a read-only mode, the floor plan acts as a viewer application.

Although, given proper authorization, the floor plan may also allow for the modification of data objects 116. In one embodiment, the processing unit 104 may receive a modification user input command relative to one of the data objects, such as a combination command or a right-mouse click and selection within a display menu, by way of example. Upon the modification command, the floor plan may launch a secondary display where this data object is editable in the secondary display.

FIG. 4 illustrates a sample screen shot 160 of a visual display generated by the floor plan. The display 160 includes tabbed display windows 162 relating to the sample business object being a children's bicycle given the product identifier CB_1100 164. In this example, a user may be a company that manufactures bicycles and has received a number of complaints concerning defects in the crank assembly on this specific bicycle model. A design engineer may utilize the central display floor plan to determine the cause of the problem.

The screenshot 160 represents one sample embodiment of how the display may look when it is initially launched. In one embodiment, the floor plan may be launched based on an active link to the data object relating to the bicycle. This sample display 160, under the “general” tab 162 provides the general bicycle data, such as might be derived from material master data in a backend system.

FIG. 5 illustrates another screenshot 170 of the central floor plan. This display includes a product structure view, as indicated by the selected tab 172. In this example, the product structure view corresponds to the bill of material associated with the material presented in the central floor plan display. The bill of material data structure may be of varying data structure, but data fields may be assembled and properly disposed on the display to provide the uniformed display as shown in screenshot 170.

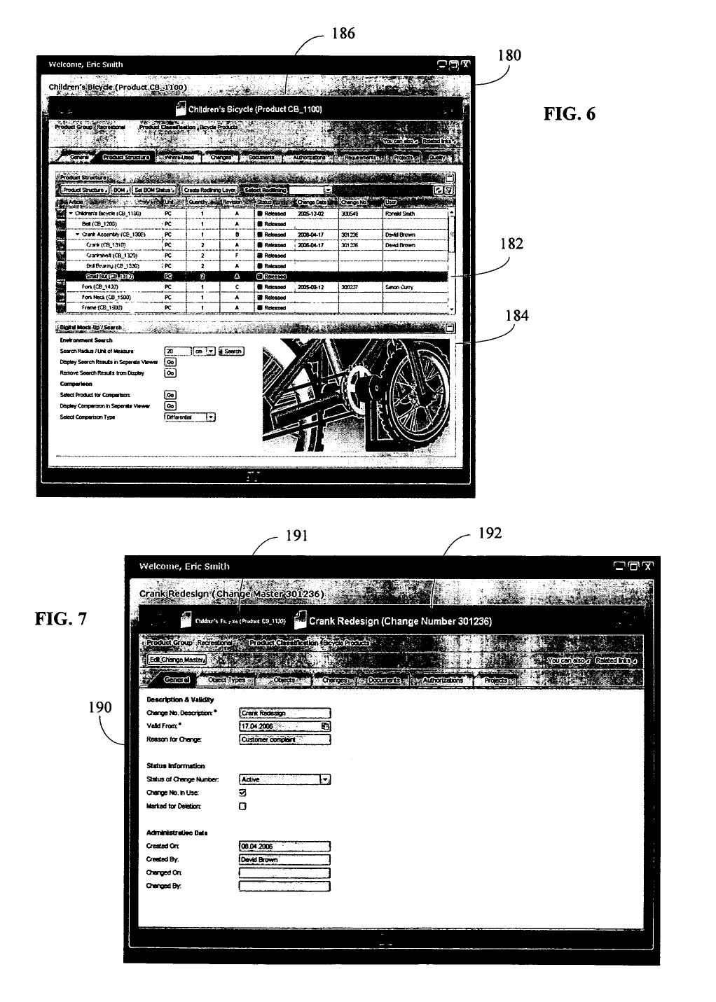

In the example of a design engineer attempting to solve customer complaint issues, FIG. 6 illustrates another screenshot 180 illustrates a user-selection of one of the items in the bill of material. In this example, the user selects the small nut, product CB_1340 data field 182. This highlighted item may be the component that was reported to have caused the consumer complaints. The selected item may now be the reference object for the digital mock-up, such as being designated in a visual display, such as illustrated in the secondary window 184. Also visible in the screenshot 180 is the object link 186 to the current display. This active linking allows for convenient user navigation through the floor plan.

Through a searching operation in FIG. 6, the engineer may determine that there may be change number associated with the specific bill of material item. The user may then navigate within the floor plan to the change number master data via a corresponding link, thereby generating the screenshot 190 of FIG. 7. The display relates to a different data object as a change number has been assigned to it. While the user continues to navigate and analyze, displaying the change number within the same floor plan supports these operations. Additionally, also visible in the screenshot 190, the objects link 191 allow for user-navigation through previously displayed windows or tabs and object link 192 is the current display.

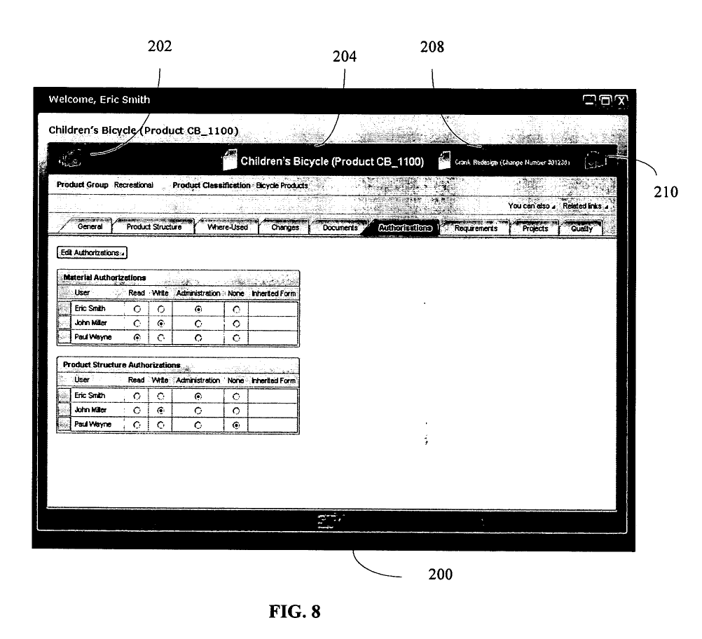

FIG. 8 illustrates another sample screenshot 200 within the floor plan, whereby it is recognized that the user has navigated back to a level consistent with the screenshot of FIG. 4. In this screenshot, the user selects authorization fields to determine who has the authority to change aspects to the data objects. But also visible in screenshot 200 is the breadcrumb trail navigation technique disposed at the top of the display. In this example, stacked indicators 202 represent any number of previous links and the active link 204 indicates the current window. Additionally, active link 208 indicates the previously viewed display of FIG. 7 relating to the Crank Redesign window. Additionally, stacked indicators 210 may indicate additional future navigation object links. Therefore, through the navigation pane at the top and the display of object links, a user may easily navigate through the floor plan.

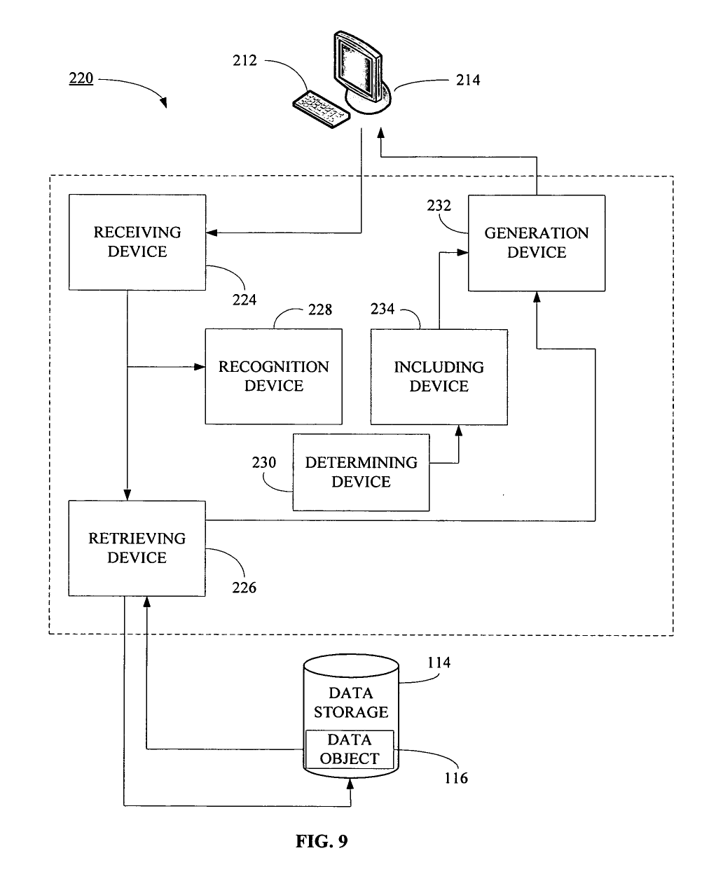

FIG. 9 illustrates another embodiment of a system 220 for displaying a plurality of data object in a central display floor plan. The system 220 includes an apparatus for displaying a plurality of data objects in a central platform, as well as a display device 214 and a input device 212. Also coupled to the apparatus 220 is the database 114 include one or more data objects 116 stored therein.

The apparatus 220 includes a receiving device 224, a retrieving device 226, a recognition device 228, a determining device 230, a generation device 232 and an including device 234. These devices 224-234 may be stand-alone processing components or may be implement as hardware, software or a combination thereof in a larger computing environment.

In one embodiment, the receiving device 224 receives a user input for product information. In response thereto, a retrieving device 226 accesses the database 114 to retrieve requested data objects 116 therefrom. The data objects are provided to the generation device 232. In one embodiment, the recognition device 228, in response to the information received from the input device 212, recognizes the selected viewable tab of the display on the central floor plan. This recognition may be used by the retrieving device in determining which data objects 116 to retrieve and may be used by the generation device 232 in generating the visual output display.

The determining device 230 determines a first object link that indicates the previous output display. This determination may be made based on previous operations, such as the loading of the previous window or display that allowed for the user input request. An including device 234 thereby coordinates with the generation device 232 to include this first object link in the visual output display on the display device 214. Thereby, user navigation is included in the multi-tabbed display provided within the central floor plan.

As such, the utilization of the central floor plan provides non-structured user interaction with a general interface. The tabbed window of the floor plan, as well as the inclusion of the object data for populating the fields, provides a uniform display of various types of information. Additionally, the inclusion of the object links provides for a bread-crumb navigation allowing a user to quickly and effectively navigate between different aspects of the floor plan. Thus, the floor plan architecture provides a holistic view of a business object across technical object borders. As well as, the floor plan supports new interaction behavior with browsing and viewing a series of different but interrelated objects within a single window instance. The floor plan allows the user to freely navigate between objects by means of embedded object links in the user interface and the bread crumb trails displayed near the top of the floor plan.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A method for displaying a plurality of data objects in a central display floor plan through a graphical user interface (GUI) engine, the method comprising:
receiving a user input request for product information from a first processing device;
through the GUI engine, retrieving a plurality of data objects from at least one object database in response to the user request;
generating a visual output display including disposing the one or more data objects in predefined positions;
determining a first object link to a previous output display, where the first object link provides an active selectable link for user navigation to the previous output display;
including the first object link in the visual output display;
receiving a second user input request for product information;
generating an updated visual display based on the second user input request;
generating a second object link for the visual output display; and
adding the second object link to the updated visual display.

2. The method of claim 1 further comprising:
upon receipt of the second user input request, determining if any additional data objects are requested;
if requested, retrieving additional data objects from the at least one object database;
if the user request selects a new viewable tab, recognizing an updated viewable tab of the central display floor plan; and
generating the updated visual display including disposing at least one of the data objects in predefined positions.

3. The method of claim 2 further comprising:
generating a third object link for the visual display.

4. The method of claim 3 further comprising:
receiving an input user selection of the second object link;
displaying the visual display output; and
updating the visual display output to include the third object link as well as the first object link.

5. The method of claim 3 wherein the updated visual display may be disposed within a tabbed display relative to the visual output display.

6. The method of claim 1 wherein the viewable data objects are in a read-only mode.

7. The method of claim 1 further comprising:
receiving a modified user input command relative to one of the data objects; and
launching a secondary display, wherein the data object is editable in the secondary display.

8. An apparatus for displaying a plurality of data objects in a central display floor plan through a graphical user interface (GUI) engine, the apparatus comprising:
an input device operative to receive a user input; and
a processing device, in response to executable instructions, operative to:
receive the user input request for product information;
through the GUI engine, retrieve a plurality of data objects from at least one object database;
generate a visual output display including disposing the one or more data objects in predefined positions;
determine a first object link to a previous output display, where the first object link provides an active selectable link for user navigation to the previous output display;
include the first object link in the visual output display;
receive a second user input request for product information;
generate an updated visual display based on the second user input request;
generate a second object link for the visual output display; and
adding the second object link to the updated visual display.

9. The apparatus of claim 8 wherein the processing device, in response to executable instructions, is further operative to:
upon receipt of the second user input request, determine if any additional data objects are requested;
if requested, retrieve additional data objects from the at least one object database;
if the user request selects a new viewable tab, recognizing an updated viewable tab of the central display floor plan; and
generate the updated visual display including disposing at least one of the data objects in predefined positions.

10. The apparatus of claim 8 wherein the processing device, in response to executable instructions, is further operative to generate a third object link for the visual display.

11. The apparatus of claim 8 wherein the processing device, in response to executable instructions, is further operative:
receive an input user selection of the second object link;
display the visual display output; and
update the visual display output to include the third object link as well as the first object link.

12. The apparatus of claim 8 wherein the updated visual display may be disposed within a tabbed display relative to the visual output display.

13. The apparatus of claim 8 wherein the viewable data objects are in a read-only mode.

14. The apparatus of claim 8 wherein the processing device, in response to executable instructions, is further operative to receive a modified user input command relative to one of the data objects and launch a secondary display, wherein the data object is editable in the secondary display.

15. A system for displaying a plurality of data objects in a central display floor plan, the system comprising:
an input device operative to receive a user input;
a display device;
a processing device operative to receive the user input from the input device and provide an output display to the display device; and
at least one object database storing data objects therein, the database in networked communication with the processing device, the processing device, in response to executable instructions, operative to:
receive the user input request for product information;
retrieve the plurality of data objects from the at least one object database in response to the user request;
generate a visual output display including disposing the one or more data objects in predefined positions for the display device;
determine a first object link to a previous output display, where the first object link provides an active selectable link for user navigation to the previous output display;
include the first object link in the visual output display on the display device;
receiving a second user input request for product information;
generating an updated visual display based on the second user input request;
generating a second object link for the visual output display; and
adding the second object link to the updated visual display.

16. The system of claim 15 wherein the processing device, in response to executable instructions, is further operative to:
upon receipt of the second user input request, determine if any additional data objects are requested;
if requested, retrieve additional data objects from the at least one object database;
if the user request selects a new viewable tab, recognizing an updated viewable tab of the central display floor plan; and
generate the updated visual display including disposing at least one of the data objects in predefined positions.

17. The system of claim 15 wherein the processing device, in response to executable instructions, is further operative to generate a third object link for the visual display.

18. The system of claim 15 wherein the processing device, in response to executable instructions, is further operative:
receive an input user selection of the second object link;
display the visual display output; and
update the visual display output to include the third object link as well as the first object link.

19. The system of claim 18 wherein the updated visual display may be disposed within a tabbed display relative to the visual output display.
